(19) United States
(12) Patent Application Publication
(10) Pub. No.: US 2006/0072846 A1
(43) Pub. Date: Apr. 6, 2006

(54) Transformation or inverse transformation method and apparatus capable of transforming or inversely transforming blocks having various sizes

(75) Inventor: Byung-cheol Song, Suwon-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/232,395

(22) Filed: Sep. 22, 2005

(30) Foreign Application Priority Data
Oct. 6, 2004 (KR) 10-2004-0079488

(51) Int. Cl. G06K 9/36; G06K 9/46

(52) U.S. Cl. 382/276; 382/250

(57) ABSTRACT

A transformation or inverse transformation method and apparatus used in an audio-video codec are provided. The transformation or inverse transformation apparatus includes: a plurality of ROM tables, which are referenced when transforming or inversely transforming input data in consideration of the format or size of the input data; and a transformation and/or inverse transformation unit, which selects one of the ROM tables in consideration of the format or size of the input data and transforms or inversely transforms the input data with reference to the selected ROM table. The transformation or inverse transformation unit simultaneously processes a total of 8 data in parallel regardless of the format or size of the input data. Accordingly, it is possible to efficiently transform or inversely transform input data regardless of the format or size of the input data.

### CROSS-REFERENCE TO RELATED APPLICATION

This application claims the benefit of Korean Patent Application No. 10-2004-0079488, filed on Oct. 6, 2004, in the Korean Intellectual Property Office, the disclosure of which is incorporated herein in its entirety by reference.

### BACKGROUND OF THE INVENTION

1. Field of the Invention

The present invention relates to a transformation or inverse transformation apparatus and, more particularly, to a transformation or inverse transformation method and apparatus which can transform or inversely transform blocks effectively regardless of the size of input blocks.

2. Description of the Related Art

Recently, Microsoft Corporation submitted a draft of a moving picture compression standard dubbed ‘VC1’ to the Society of Motion Picture and Television Engineers (SMPTE), an international standardization body. Currently, the examination of VC1 is underway, and many experts expect VC1 to be adopted as an international standard sooner or later.

VC1 is also expected to become a leading moving picture compression standard in the near future, like Motion Picture Experts Group (MPEG)-2, MPEG-4, and H.264, which have already been adopted as moving picture compression standards and have been widely applied to various fields. VC1 is about 60% less complicated than H.264 and achieves almost 80% of the compression efficiency of H.264, which is considered as one of the most efficient moving picture compression standards in terms of compression efficiency. In addition, VC1 is also known to provide a higher picture quality than MPEG-2 or MPEG-4.

VC1 provides slightly different tools from other standards. Specifically, MPEG-2 and H.264 adopt a predictive transformation compression method. In other words, in MPEG-2 and H.264, temporal redundancies are removed through motion estimation and compensation, and spatial redundancies are removed through discrete cosine transformation (DCT) (or inverse DCT) and quantization (or inverse quantization). However, MPEG-2 and H.264 are different from each other because MPEG-2 adopts an 8×8 DCT (or inverse DCT) method but H.264 adopts a 4×4 integer transformation method.

VC1, unlike MPEG-2 or H.264, is used for transforming or inversely transforming inter-macroblocks in units of 8×8, 8×4, 4×8, or 4×4 blocks. Therefore, the time required for processing each of the inter-macroblocks increases, and the control of the processing of each of the inter-macroblocks becomes complicated.

### SUMMARY OF THE INVENTION

Additional aspects and/or advantages of the invention will be set forth in part in the description which follows and, in part, will be apparent from the description, or may be learned by practice of the invention.

The present invention provides a transformation or inverse transformation method and apparatus which can transform or inversely transform blocks effectively and quickly regardless of the sizes of input blocks and can be easily controlled.

According to an aspect of the present invention, there is provided a transformation or inverse transformation apparatus used in an audio-video codec. The transformation or inverse transformation apparatus includes: a plurality of ROM tables, which are referenced when transforming or inversely transforming input data in consideration of the format or size of the input data; and a transformation or inverse transformation unit, which selects one of the ROM tables in consideration of the format or size of the input data and transforms or inversely transforms the input data with reference to the selected ROM table. The transformation or inverse transformation unit simultaneously processes a total of 8 data in parallel regardless of the format or size of the input data.

The transformation or inverse transformation unit may include: a first transformation or inverse transformation unit, which performs a transformation or inverse transformation operation on the input data in a row direction; and a second transformation or inverse transformation unit, which performs a transformation or inverse transformation operation on the input data in a column direction.

The transformation or inverse transformation apparatus may also include a transpose operation unit, which performs a transpose operation on the input data processed by the first transformation or inverse transformation unit so that rows and columns of the input data can be transposed.

The transpose operation unit may perform a transpose operation on the input data processed by the first transformation or inverse transformation unit in units of 8×8 blocks.

If the type of transformation or inverse transformation to be performed on the input data is 8×8 or 8×4, the first transformation or inverse transformation unit may perform an 8-point transformation or inverse transformation operation on each row of the input data, which is comprised of 8 coefficients, and otherwise, the first transformation or inverse transformation unit may perform a pair of 4-point transformation or inverse transformation operations in parallel on each row of the input data.

If the type of transformation or inverse transformation to be performed on the input data is 8×8 or 8×4, the second transformation or inverse transformation unit may perform an 8-point transformation or inverse transformation operation on each row of the input data, which is comprised of 8 coefficients, and otherwise, the second transformation or inverse transformation unit may perform a pair of 4-point transformation or inverse transformation operations in parallel on each column of the input data.

The format of the input data may be one of MPEG-2 and VC1. The size of the input data may be one of 8×8, 8×4, 4×8, and 4×4. The transformation or inverse transformation unit may have the same structure regardless of the format or size of the input data.

According to another aspect of the present invention, there is provided an audio-video codec that includes a transformation or inverse transformation apparatus and supports multiple data formats. The transformation or inverse transformation apparatus includes: a plurality of ROM tables, which are referenced when transforming or inversely transforming input data in consideration of the format or size of the input data; and a transformation or inverse transformation unit, which selects one of the ROM tables in consideration of the format or size of the input data and transforms or inversely transforms the input data based on the selected ROM table. The transformation or inverse transformation unit simultaneously processes a total of 8 data in parallel regardless of the format or size of the input data.

According to another aspect of the present invention, there is provided a transformation or inverse transformation method used in an audio-video codec. The transformation or inverse transformation method includes: selecting one of a plurality of ROM tables based on the format or size of the input data; and transforming or inversely transforming the input data based on the selected ROM table. In the transforming or inversely transforming of the input data, a total of 8 data may be simultaneously processed in parallel regardless of the format or size of the input data.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram of an inverse transformation apparatus according to an embodiment of the present invention;

FIG. 2 is a detailed block diagram of a first or second inverse transformation unit of FIG. 1;

FIG. 3 is a diagram illustrating the operation of a transpose operation unit of FIG. 1;

FIG. 4 is a flowchart of an inverse transformation method according to an embodiment of the present invention;

FIG. 5 is a diagram illustrating the inverse transformation of an 8×8 block, according to an embodiment of the present invention;

FIG. 6 is a diagram illustrating the inverse transformation of an 8×8 block, which is comprised of a pair of 8×4 blocks according to an embodiment of the present invention;

FIG. 7 is a diagram illustrating the inverse transformation of an 8×8 block, which is comprised of a pair of 4×8 blocks, according to an embodiment of the present invention; and

FIG. 8 is a diagram illustrating the inverse transformation of an 8×8 block, which is comprised of two pairs of 4×4 blocks, according to an embodiment of the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

The present invention will now be described more fully with reference to the accompanying drawings in which exemplary embodiments of the invention are shown.

Transformation and inverse transformation are basically the same except that they use different matrices. Therefore, for the convenience of explanation, the present invention will now be described in detail focusing only on inverse transformation. However, it is obvious that various principles applied in this disclosure to inverse transformation are directly applicable to transformation as well.

A VC1 image compression method provides four types of inverse transformation, i.e., 8×8 inverse transformation, 8×4 inverse transformation, 4×8 inverse transformation, and 4×4 inverse transformation, which are different from one another in terms of the size of blocks that they can process. Each of the four types of inverse transformation involves three operations, i.e., performing a first one-dimensional (1D) inverse transformation operation in a row direction, performing a transpose operation, and performing a second 1D inverse transformation operation in a column direction. This type of inverse transformation is called 2D inverse transformation because a pair of 1 D inverse transformations are performed in a row direction and then in a column direction. The transpose operation is performed using two groups of registers between the first and second 1D inverse transformation operations.

FIG. 1 is a block diagram of an inverse transformation apparatus 1 according to an embodiment of the present invention. Referring to FIG. 1, the inverse transformation apparatus 1 includes a first inverse transformation unit 10, which performs a 1D inverse transformation operation on input data in a row direction, a transpose operation unit 20, which performs a transpose operation using two groups of registers in order to transpose columns and rows of the input data, and a second inverse transformation unit 30, which performs a 1D inverse transformation operation on the input data in a column direction. The first and second inverse transformation units 10 and 30 have the same structure except that they deal with different sizes of data and use different ROM tables, which will be described later in detail.

A VC1 inverse transformation method will now be described in detail. Detailed descriptions of a matrix used for performing an inverse transformation operation on an 8-point block and a matrix used for performing an inverse transformation operation on a 4-point block will be presented first in the following paragraphs.

A matrix T₈ used for performing a first inverse transformation operation on an 8-point block in a row direction is as follows:

$${T}_{8} = [ \begin{matrix}a & a & a & a & a & a & a & a \\ b & d & e & g & - g & - e & - d & - b \\ c & f & - f & - c & - c & - f & f & c \\ d & - g & - b & - e & e & b & g & - d \\ a & - a & - a & a & a & - a & - a & a \\ e & - b & g & d & - d & - g & b & - e \\ f & - c & c & - f & - f & c & - c & f \\ g & - e & d & - b & b & - d & e & - g\end{matrix} ]$$

$$where [ \begin{matrix}a \\ b \\ c \\ d \\ e \\ f \\ g\end{matrix} ] = [ \begin{matrix}12 \\ 16 \\ 16 \\ 15 \\ 9 \\ 6 \\ 4\end{matrix} ] .$$

A matrix T₈′^{e} used for performing a second inverse transformation operation on the 8-point block in a column direction is as follows:

$${T}_{8}^{′ e} = [ \begin{matrix}\overline{a} & \overline{b} & \overline{c} & \overline{d} & \overline{a} & \overline{e} & \overline{f} & \overline{g} \\ \overline{a} & \overline{d} & \overline{f} & - \overline{g} & - \overline{a} & - \overline{b} & - \overline{c} & - \overline{e} \\ \overline{a} & \overline{e} & - \overline{f} & - \overline{b} & - \overline{a} & \overline{g} & \overline{c} & \overline{d} \\ \overline{a} & \overline{g} & - \overline{c} & - {\overline{e}}^{i} & \overline{a} & \overline{d} & - \overline{f} & - \overline{b} \\ \overline{a} & - \overline{g} & - \overline{c} & {\overline{e}}^{1} & \overline{a} & - \overline{d} & - \overline{f} & \overline{b} \\ \overline{a} & - \overline{e} & - \overline{f} & \overline{b} & - \overline{a} & - \overline{g} & \overline{c} & - \overline{d} \\ \overline{a} & - \overline{d} & \overline{f} & \overline{g} & - \overline{a} & \overline{b} & - \overline{c} & \overline{e} \\ \overline{a} & - \overline{b} & \overline{c} & - \overline{d} & \overline{a} & - \overline{e} & \overline{f} & - \overline{g}\end{matrix} ]$$

$$where [ \begin{matrix}\overline{a} \\ \overline{b} \\ \overline{c} \\ \overline{d} \\ \overline{e} \\ \overline{f} \\ \overline{g}\end{matrix} ] = [ \begin{matrix}6 \\ 8 \\ 8 \\ 7 \\ 4 \\ 3 \\ 2\end{matrix} ] .$$

A correction matrix Δ used in the second inverse transformation operation performed on the 8-point block is as follows:

$$Δ = [ \begin{matrix}{D}_{2 a}^{′} \\ {D}_{2 b}^{′} \\ {D}_{2 b}^{′} \\ {D}_{2 a}^{′} \\ - {D}_{2 a}^{′} \\ - {D}_{2 b}^{′} \\ - {D}_{2 b}^{′} \\ - {D}_{2 a}^{′}\end{matrix} ]$$

$$where [ {D}_{1 a} {D}_{1 b} ] = {D}_{1}^{′} [ \begin{matrix}0 & 0 \\ 0 & 1 \\ 0 & 0 \\ 1 & 0 \\ 0 & 0 \\ 1 & 0 \\ 0 & 0 \\ 0 & 1\end{matrix} ] .$$

A matrix T₄ used for performing a first inverse transformation operation on a 4-point block in a row direction is as follows:

$${T}_{4} = [ \begin{matrix}k & k & k & k \\ l & m & - m & - l \\ k & - k & - k & k \\ m & - l & l & - m\end{matrix} ]$$

$$where [ \begin{matrix}k \\ l \\ m\end{matrix} ] = [ \begin{matrix}17 \\ 22 \\ 10\end{matrix} ] .$$

A matrix T₄′^{e} used for performing a second inverse transformation operation on the 4-point block in a column direction is as follows:

$${T}_{4}^{{r}^{e}} = [ \begin{matrix}\overline{k} & \overline{l} & \overline{k} & \overline{m} \\ \overline{k} & \overline{m} & - \overline{k} & - \overline{l} \\ \overline{k} & - \overline{m} & - \overline{k} & \overline{l} \\ \overline{k} & - \overline{l} & \overline{k} & - \overline{m}\end{matrix} ]$$

$$where [ \begin{matrix}\overline{k} \\ \overline{l} \\ \overline{m}\end{matrix} ] = [ \begin{matrix}8 \\ 11 \\ 5\end{matrix} ] .$$

Equations representing inverse transformation operations for inversely transforming blocks having various sizes using the above-mentioned matrices T₈, T₈′^{e}, Δ, T₄, and T₄′^{e} will be presented in the following paragraphs.

1) 8×8 Inverse Transformation

A first inverse transformation operation is performed on an 8-point block in a row direction using the matrix T₈. The first inverse transformation operation can be expressed using Equation (1):
D₁=(D·T₈+4)>>3
where D is an 8-point block to be inversely transformed, and D₁ is an 8-point block obtained as a result of performing a first inverse transformation on the 8-point block D in a row direction using the matrix T₈.

Once D₁ is obtained, a transpose operation is performed on the 8-point block D₁ so that rows and columns of the 8-point block D₁ can be transposed. Thereafter, a second inverse transformation operation is performed on the transposed 8-point block D₁ in a column direction using the matrices T₈′^{e} and Δ. The second inverse transformation operation can be expressed using Equation (2):
R=└T₈′^{e}·D₁+Δ+32┘>>6
where R is a result of performing a second inverse transformation on the transposed 8-point block D₁ in a column direction using the matrices T₈′^{e} and Δ.

2) 8×4 Inverse Transformation

A first inverse transformation operation is performed on a 4-point block in a row direction using the matrix T₄. The first inverse transformation operation can be expressed using Equation (3):
D₁=(D·T₄+4)>>3
where D is a 4-point block to be inversely transformed, and D₁ is a 4-point block obtained as a result of performing a first inverse transformation operation on the 4-point block D in a row direction using the matrix T₄.

Thereafter, a transpose operation is performed on the 4-point block D₁ so that rows and columns of the 4-point block D₁ can be transposed. Thereafter, a second inverse transformation operation is performed on the transposed 4-point block D₁ in a column direction using the matrices T₈′^{e} and Δ. The second inverse transformation operation can be expressed using Equation (4):
R=└T₈′³·D₁+Δ+32┘>>6
where R is a result of performing a second inverse transformation on the transposed 4-point block D₁ in a column direction using the matrices T₈′^{e} and Δ.

3) 4×8 Inverse Transformation

A first inverse transformation operation is performed on an 8-point block in a row direction using the matrix T₈. The first inverse transformation operation can be expressed using Equation (5):
D₁=(D·T₈+4)>>3
where D is an 8-point block to be inversely transformed, and D₁ is an 8-point block obtained as a result of performing a first inverse transformation on the 8-point block D in a row direction using the matrix T_{8.}

Thereafter, a transpose operation is performed on the 8-point block D₁ so that rows and columns of the 8-point block D₁ can be transposed. Thereafter, a second inverse transformation operation performed on the transposed 8-point block D₁ in a column direction using the matrices T₄′^{e} and Δ can be expressed using Equation (6):
R=└T₄′^{e}·D₁+Δ+32┘>>6
where R is a result of performing a second inverse transformation on the transposed 8-point block D₁ in a column direction using the matrices T₄′^{e} and Δ.

4) 4×4 Inverse Transformation

A first inverse transformation operation is performed on a 4-point block in a row direction using the matrix T₄. The first inverse transformation operation can be expressed using Equation (7):
D₁=(D·T₄+4)>>3
where D is a 4-point block to be inversely transformed, and D₁ is a 4-point block obtained as a result of performing a first inverse transformation on the 4-point block D in a row direction using the matrix T₄.

Thereafter, a transpose operation is performed on the 4-point block D₁ so that rows and columns of the 4-point block D₁ can be transposed. Thereafter, a second inverse transformation operation is performed on the transposed 4-point block D₁ in a column direction using the matrices T₄′^{e} and Δ. The second inverse transformation can be expressed using Equation (8):
R=└T₄′^{e}·D₁+Δ+32┘<<6
where R is a result of performing a second inverse transformation on the transposed 4-point block D₁ in a column direction using the matrices T₄′^{e} and Δ.

The above-described inverse transformation operations can be realized as hardware in various manners. An example of such hardware is a transformation apparatus capable of transforming blocks having various sizes using a plurality of ROM tables and a multiplexer. The transformation apparatus is disclosed in Korean Patent Application No. 10-2004-55894 filed on Jul. 19, 2004 by the same applicant as the present invention.

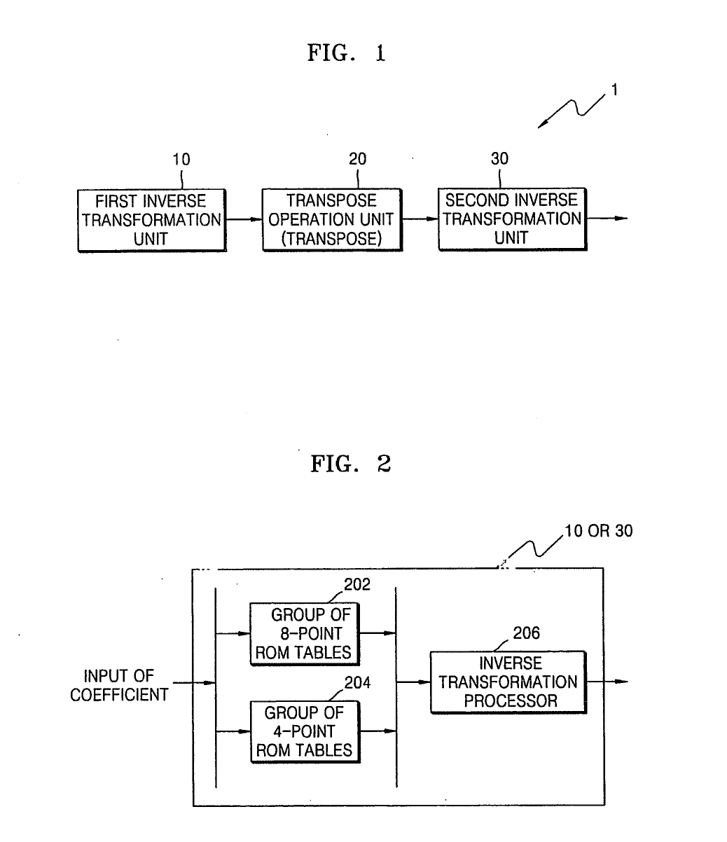

FIG. 2 is a detailed block diagram of the first or second inverse transformation unit 10 or 30 of FIG. 1. Referring to FIG. 2, the first or second inverse transformation unit 10 or 30 includes one or more ROM tables, i.e., a group of 8-point ROM tables 202 and a group of 4-point ROM tables 204, and an inverse transformation processor 206.

Each of the ROM tables of the first or second inverse transformation unit 10 or 30 includes the matrices T₈, T₈′^{e}, Δ, T₄, and T₄′^{e} required for inversely transforming blocks having various sizes. Specifically, each of the 8-point ROM tables 202 includes the matrices T₈ and T₈′^{e}, and each of the 4-point ROM tables 204 includes the matrices T₄ and T₄′^{e}. Therefore, when data is input to the inverse transformation apparatus 1 of FIG. 1, one of the 8-point ROM tables 202 or one of the 4-point ROM tables 204 is selected based on the size of the input data, i.e., whether the input data has a size of 8×8, 8×4, 4×8, or 4×4. Then, the inverse transformation processor 206 performs an inverse transformation operation on the input data with reference to the selected ROM table.

Accordingly, the inverse transformation apparatus 1 of FIG. 1 can deal with data with various sizes by simply using different ROM tables without the need to be modified hardwarewise, while a conventional DCT apparatus based on MPEG-2 can receive and process only data having a fixed size, i.e., a size of 8×8.

The inverse transformation processor selects one of the 8-point ROM tables 202 or one of the 4-point ROM tables 204 in consideration of the size of input data and then performs an inverse transformation operation on the input data with reference to the selected ROM table.

In short, the first or second inverse transformation unit 10 or 30 includes the 8-point ROM tables 202 and the 4-point ROM tables 204 in order to process data having various sizes, such as sizes of 8×8, 8×4, 4×8, and 4×4. The inverse transformation processor 206 selects one of the 8-point ROM tables 202 or one of the 4-point ROM tables 204 in consideration of the size of multiplexed data input to the first or second inverse transformation unit 10 or 30. Thereafter, the inverse transformation processor 206 performs an inverse transformation on the input multiplexed data with reference to the selected ROM table. Accordingly, it is possible to efficiently perform an inverse transformation operation on data regardless of the size or type of the data without modifying the hardware structure of the inverse transformation apparatus 1 of FIG. 2.

In addition, it is possible to inversely transform 8×8 blocks coded in MPEG as well as 8×8 blocks coded in VC1 using the inverse transformation apparatus 1 of FIG. 2. Therefore, it is possible to realize a multi-format decoder using the inverse transformation apparatus 1 of FIG. 2.

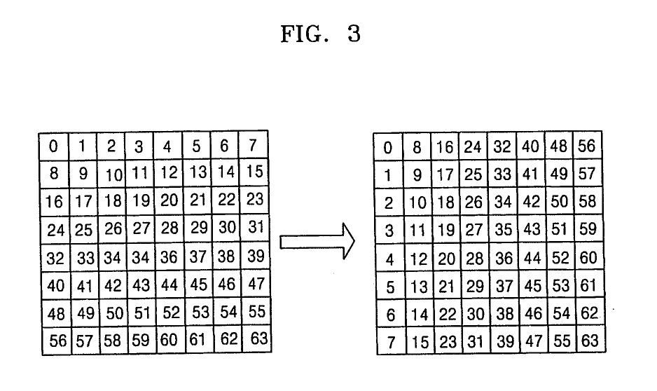

FIG. 3 is a diagram illustrating the operation of the transpose operation unit 20 of FIG. 1. Referring to FIGS. 1 and 3, the transpose operation unit 20 transposes rows and columns of a block which has undergone a row-directional first inverse transformation operation performed by the first inverse transformation unit 10 as part of preparation for performing a second inverse transformation operation on the block in a column direction. If the block has a size of 8×8, the transpose operation unit 20 performs an 8×8 transpose operation on the block. An example of the 8×8 transpose operation is illustrated in FIG. 3. If the block has a size of 8×4, 4×8, or 4×4, the transpose operation unit 20 can perform a transpose operation compatible with the size of the block.

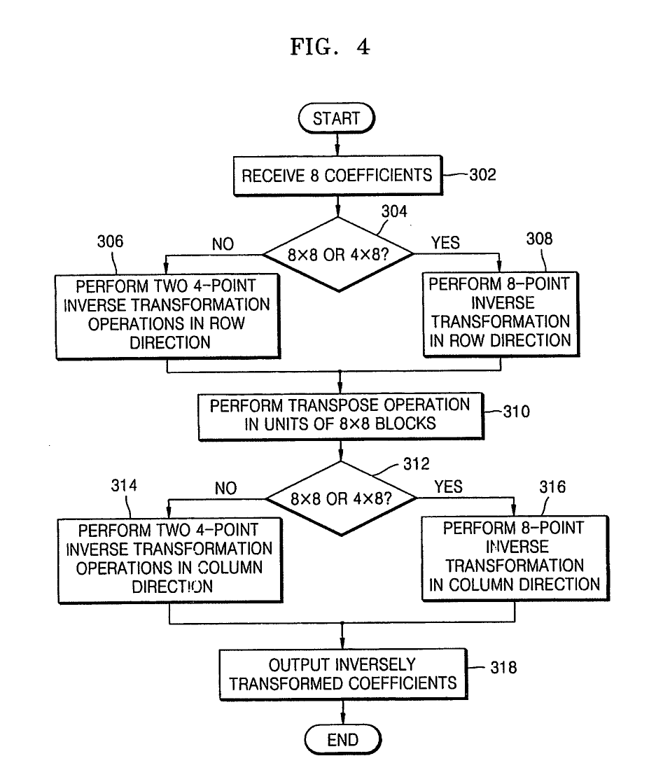

The operation of the inverse transformation apparatus 1 of FIG. 1 described above with reference to FIGS. 3 and 4 can be summarized as follows.

1) Inverse Transformation of 8×8 Block

An 8-point inverse transformation operation is performed on an 8×8 block in a row direction, rows and columns of the 8×8 block are transposed through an 8×8 transpose operation, and the 8-point inverse transformation operation is performed on the transposed 8×8 block in a column direction.

2) Inverse Transformation of 8×4 Block

A 4-point inverse transformation operation is performed 8 times on an 8×4 block in a row direction, rows and columns of the 8×4 block are transposed through an 8×4 transpose operation, and an 8-point inverse transformation operation is performed 4 times on the transposed 8×4 block in a column direction. A total of two iterations of the 4-point inverse transformation operation, the 8×4 transpose operation, and the 8-point inverse transformation operation are performed.

3) Inverse Transformation of 4×8 Block

A first 8-point inverse transformation operation is performed 4 times on a 4×8 block in a row direction, rows and columns of the 4×8 block are transposed through a 4×8 transpose operation, and a second 8-point inverse transformation operation is performed 4 times on the transposed 4×8 block in a column direction. A total of two iterations of the first 8-point inverse transformation operation, the 4×8 transpose operation, and the second 8-point inverse transformation operation are performed.

4) Inverse Transformation of 8×8 Block

A first 4-point inverse transformation operation is performed 4 times on a 4×4 block in a row direction, rows and columns of the 4×4 block are transposed through a 4×4 transpose operation, and a second 4-point inverse transformation operation is performed 4 times on the transposed 4×4 block in a column direction. A total of four iterations of the first 4-point inverse transformation operation, the 4×4 transpose operation, and the second 4-point inverse transformation operation are performed.

As described above, the present embodiment may cause the following problems even though it can inversely transform blocks having various sizes. First, in the case of processing an 8×4 or 4×8 block, the processing cycle of performing a first inverse transformation operation on the 8×4 or 4×8 block and the processing cycle of performing a second inverse transformation operation on the 8×4 or 4×8 block are not symmetrical, and thus, the entire processing cycle of inversely transforming the 8×4 or 4×8 block is up to doubled compared to the entire processing cycle of inversely transforming an 8×8 block because, in the inversely transforming of the 8×4 or 4×8 block, a total of two iterations of the first inverse transformation operation, a transpose operation, and the second inverse transformation should be performed. Due to the hardware structure of the inverse transformation apparatus 1, the time required for performing a 4-point inverse transformation operation is the same as the time required for performing an 8-point inverse transformation operation. For the same reason, the entire processing cycle of inversely transforming a 4×4 block is up to quadrupled compared to the entire processing cycle of inversely transforming an 8×8 block. Second, in the present embodiment, blocks having different sizes are transposed through different types of transpose operations, and thus it becomes difficult to control the operation of the transpose operation unit 20.

In order to solve these problems, an inverse transformation method in which an inverse transformation operation is performed in units of 8 data is suggested. In the inverse transformation method, a first inverse transformation operation is performed in parallel on 8 data, an 8×8 transpose operation is performed once on the 8 data, and a second inverse transformation operation is performed in parallel on the 8 data. The structure of an inverse transformation apparatus that performs this type of inverse transformation method is the same as the inverse transformation apparatus 1 of FIG. 2. In other words, the inverse transformation apparatus, like the inverse transformation apparatus 1 of FIG. 2, includes a first inverse transformation unit, a transpose operation unit, and a second inverse transformation unit. Each of the first and second transformation units performs two 4-point inverse transformation operations or an 8-point inverse transformation operation. The transpose operation unit performs an 8×8 transpose operation regardless of the size of blocks input thereto. This type of inverse transformation method will now be described in detail with reference to FIG. 4.

FIG. 4 is a flowchart of an inverse transformation method according to an embodiment of the present invention. Referring to FIG. 4, in operation 302, 8 coefficients are simultaneously received in units of 8×8 blocks regardless of the type of inverse transformation to be performed on input data. If the type of inverse transformation to be performed on the input data is 8×8 or 4×8 in operation 304, an 8-point inverse transformation operation is performed on the input data in a row direction in operation 308. If the type of inverse transformation to be performed on the input data is 8×4 or 4×4 in operation 304, two 4-point inverse transformation operations are simultaneously performed on the input data in operation 306. Accordingly, it is possible to prevent the entire processing cycle of inversely transforming the input data from unnecessarily lengthening by performing two 4-point inverse transformation operations in parallel on the input data. In addition, the result of simultaneously performing two 4-point inverse transformation operations on the input data is the same as a result of performing an 8-point inverse transformation operation on the input data regardless of the size of the type of inverse transformation to be performed on the input data.

In operation 310, rows and columns of the input data that has been primarily inversely transformed in operation 306 are transposed through a transpose operation. An example of the transpose operation is illustrated in FIG. 3.

If the type of inverse transformation to be performed on the transposed input data is 8×8 or 8×4 inverse transformation in operation 312, an 8-point inverse transformation operation is performed on the transposed input data in a row direction in operation 316. Otherwise, two 4-point inverse transformation operations are simultaneously performed on the transposed input data in a column direction in operation 314. In operation 314, like in operation 306, two 4-point inverse transformation operations are simultaneously carried out, thus preventing the entire processing cycle of inversely transforming the input data. In operation 318, 8 inversely transformed coefficients are output.

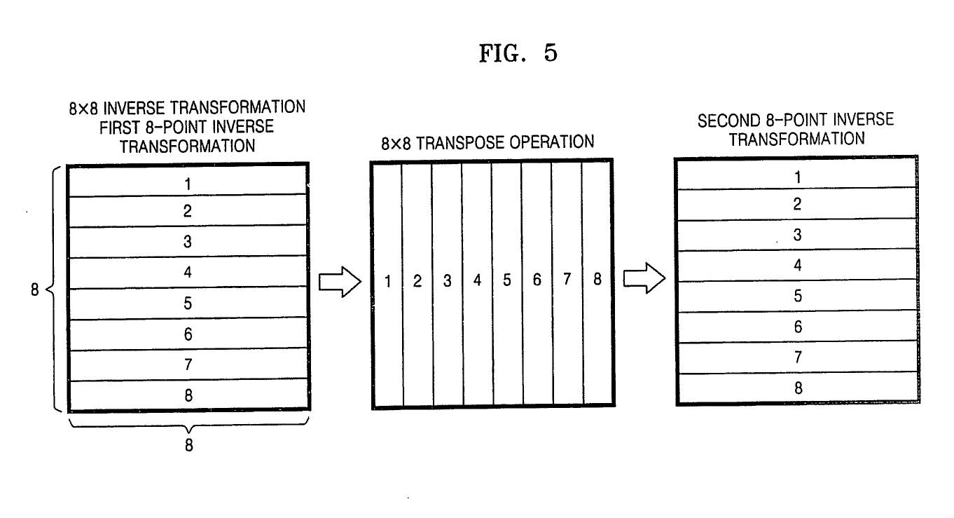

FIG. 5 is a diagram illustrating the inverse transformation of an 8×8 block according to an exemplary embodiment of the present invention. Referring to FIG. 5, a first 8-point inverse transformation is performed on the 8×8 block so that rows 1, 2, 3, 4, 5, 6, 7, and 8 of the 8×8 block can be sequentially inversely transformed, as shown in the left side of FIG. 5. Thereafter, an 8×8 transpose operation is performed on the 8×8 block so that rows and columns of the 8×8 block can be transposed, as shown in the middle of FIG. 5. Thereafter, a second 8-point inverse transformation operation is performed on the transposed 8×8 block so that rows 1, 2, 3, 4, 5, 6, 7, and 8 of the transposed 8×8 block can be sequentially inversely transformed, as shown in the right side of FIG. 5.

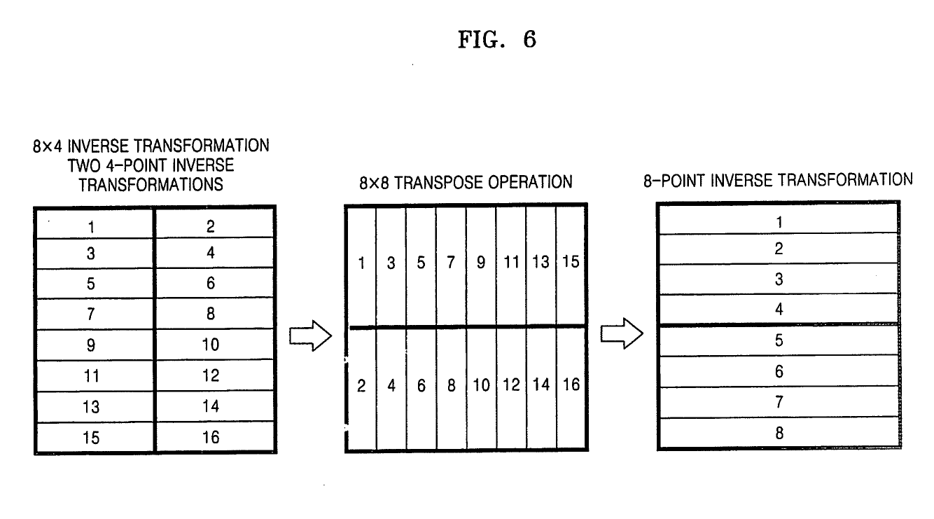

FIG. 6 is a diagram illustrating the inverse transformation of an 8×8 block, which is comprised of a pair of 8×4 blocks, i.e., first and second 8×4 blocks, according to an exemplary embodiment of the present invention. Referring to FIG. 6, two 4-point inverse transformation operations are simultaneously performed on the first and second 8×4 blocks so that rows 1, 3, 5, 7, 9, 11, 13, and 15 in the first 8×4 block can be sequentially inversely transformed together with rows 2, 4, 6, 8, 10, 12, 14, and 16, respectively, in the second 8×4 block, as shown in the left side of FIG. 6. In other words, rows 1, 3, 5, 7, 9, 11, 13, and 15 in the first 8×4 block are sequentially inversely transformed while rows 2, 4, 6, 8, 10, 12, 14, and 16 in the second 8×4 block are sequentially inversely transformed. Thereafter, an 8×8 transpose operation is performed on the 8×8 block so that the rows and columns of the 8×8 block can be transposed, as shown in the middle of FIG. 6. Thereafter, an 8-point inverse transformation operation is performed on the transposed 8×8 block so that rows 1, 2, 3, and 4 in the upper half of the transposed 8×8 block, i.e., in the first 8×4 block, can be sequentially inversely transformed and then rows 5, 6, 7, and 8 in the lower half of the transposed 8×8 block, i.e., in the second 8×4 block, can be sequentially inversely transformed, as shown in the right side of FIG. 6.

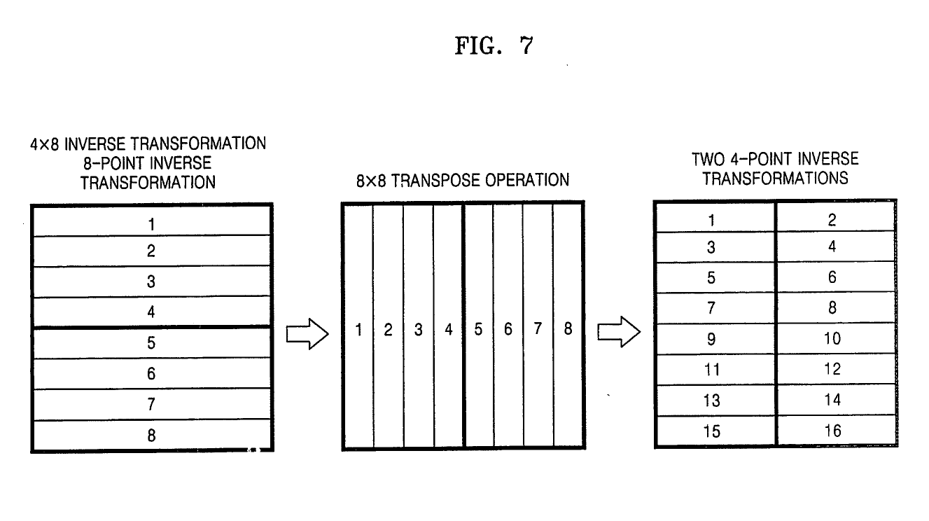

FIG. 7 is a diagram illustrating the inverse transformation of an 8×8 block, which is comprised of a pair of 4×8 blocks, i.e., first and second 4×8 blocks, according to an exemplary embodiment of the present invention. Referring to FIG. 7, an 8-point inverse transformation operation is performed on the 8×8 block so that rows 1, 2, 3, 4, 5, 6, 7, and 8 of the 8×8 block can be sequentially inversely transformed, as shown in the left side of FIG. 7. Thereafter, an 8×8 transpose operation is performed on the 8×8 block so that the rows and columns of the 8×8 block can be transposed, as shown in the middle of FIG. 7. Thereafter, two 4-point inverse transformation operations are performed on the transposed 8×8 block so that rows 1, 3, 5, 7, 9, 11, 13, and 15 in the left half of the transposed 8×8 block can be sequentially inversely transformed together with rows 2, 4, 6, 8, 10, 12, 14, and 16, respectively, in the right half of the transposed 8×8 block, as shown in the right side of FIG. 7.

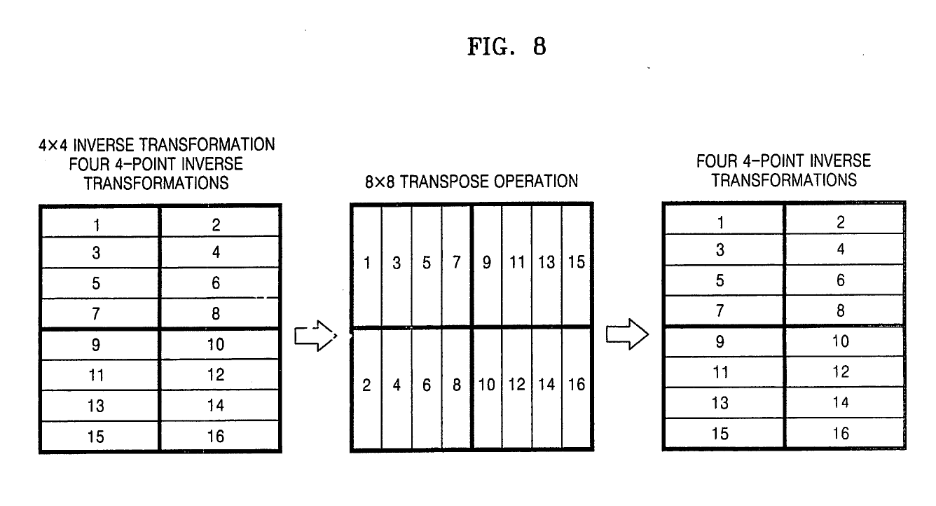

FIG. 8 is a diagram illustrating the inverse transformation of an 8×8 block, which is comprised of two pairs of 4×4 blocks, according to an exemplary embodiment of the present invention. Referring to FIG. 8, a first pair of 4-point inverse transformation operations are performed in parallel on the left and right halves of the 8×8 block so that rows 1, 3, 5, 7, 9, 11, 13, and 15 in the left half of the 8×8 block can be sequentially inversely transformed together with rows 2, 4, 6, 8, 10, 12, 14, and 16, respectively, in the second half of the 8×8 block, as shown in the left side of FIG. 8. In other words, rows 1, 3, 5, 7, 9, 11, 13, and 15 are sequentially inversely transformed through a 4-point inverse transformation operation while rows 2, 4, 6, 8, 10, 12, 14, and 16 are sequentially inversely transformed through a 4-point inverse transformation operation. Thereafter, an 8×8 transpose operation is performed on the 8×8 block so that rows and columns of the 8×8 block can be transposed, as shown in the middle of FIG. 8. Thereafter, a second pair of 4-point inverse transformation operations are performed in parallel on the left and right halves of the transposed 8×8 block so that rows 1, 3, 5, 7, 9, 11, 13, and 15 in the left half of the transposed 8×8 block can be sequentially inversely transformed together with rows 2, 4, 6, 8, 10, 12, 14, and 16, respectively, in the right half of the 8×8 block, as shown in the right side of FIG. 8.

An inverse transformation method in which an inverse transformation operation is performed in units of 8 data has been described above. In the inverse transformation method, a first inverse transformation operation is performed in parallel on the 8 data, an 8×8 transpose operation is performed on the 8 data, and a second inverse transformation operation is performed in parallel on the 8 data. The hardware structure of an inverse transformation apparatus that performs this type of inverse transformation method is the same as the inverse transformation apparatus 1 of FIG. 2. In other words, the inverse transformation apparatus, like the inverse transformation apparatus 1 of FIG. 2, includes first and second inverse transformation units and a transpose operation unit. Each of the first and second inverse transformation units performs a pair of 4-point inverse transformation operations or an 8-point inverse transformation operation in consideration of the size of blocks input thereto. The transpose operation unit always performs an 8×8 transpose operation regardless of the size of blocks input thereto.

The embodiments of the present invention have been described taking 8×8 blocks. However, the present invention can also be applied to various sizes of blocks other than those having a size of 8×8.

As described above, according to the present invention, it is possible to efficiently inversely transform data regardless of the size or type of the data. Specifically, a first or second inverse transformation unit can simultaneously process a total of 8 coefficients by performing an inverse transformation operation in parallel on the data, and a transpose operation unit always the same type of transpose operation on the data regardless of the size or type of the data. Thus, it is possible to shorten the processing cycle of inversely transforming the data and to reduce complexity in terms of the structure and operation of the transpose operation unit.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A transformation and/or inverse transformation apparatus used in an audio and/or video codec, the transformation or inverse transformation apparatus comprising:
a plurality of ROM tables, which are referenced when transforming and/or inversely transforming input data in consideration of the format or size of the input data; and
a transformation and/or inverse transformation unit, which selects one of the ROM tables in consideration of the format or size of the input data and transforms and/or inversely transforms the input data with reference to the selected ROM table,
wherein the transformation and/or inverse transformation unit simultaneously processes a total of 2M data in parallel regardless of the format or size of the input data;
wherein the M is an integer.

2. The transformation or inverse transformation apparatus of claim 1, wherein the transformation or inverse transformation unit comprises:
a first transformation and/or inverse transformation unit, which performs a transformation or inverse transformation operation on the input data in a row direction; and
a second transformation and/or inverse transformation unit, which performs a transformation or inverse transformation operation on the input data in a column direction.

3. The transformation or inverse transformation apparatus of claim 2, further comprising a transpose operation unit, which performs a transpose operation on the input data processed by the first transformation and/or inverse transformation unit so that rows and columns of the input data can be transposed.

4. The transformation or inverse transformation apparatus of claim 3, wherein the transpose operation unit performs a transpose operation on the input data processed by the first transformation or inverse transformation unit in units of 2M×2M blocks.

5. The transformation or inverse transformation apparatus of claim 2, wherein if the type of transformation or inverse transformation to be performed on the input data is 2M×2M or 2M×M, the first transformation or inverse transformation unit performs an 2M-point transformation or inverse transformation operation on each row of the input data, which is comprised of 2M coefficients, and otherwise, the first transformation or inverse transformation unit performs a pair of M-point transformation and/or inverse transformation operations in parallel on each row of the input data.

6. The transformation or inverse transformation apparatus of claim 2, wherein if the type of transformation or inverse transformation to be performed on the input data is 2M×2M or 2M×M, the second transformation or inverse transformation unit performs an 2M-point transformation or inverse transformation operation on each row of the input data, which is comprised of 2M coefficients, and otherwise, the second transformation or inverse transformation unit performs a pair of M-point transformation or inverse transformation operations in parallel on each column of the input data.

7. The transformation or inverse transformation apparatus of claim 1, wherein the format of the input data is one of MPEG-2 and VC1.

8. The transformation or inverse transformation apparatus of claim 1, wherein the size of the input data is one of 8×8, 8×4, 4×8, and 4×4.

9. The transformation and/or inverse transformation apparatus of claim 1, wherein the transformation and/or inverse transformation unit always has the same structure regardless of the format or size of the input data.

10. The transformation and/or inverse transformation apparatus of claim 1, wherein the M is 4.

11. The transformation and/or inverse transformation apparatus of claim 4, wherein the 2M×2M block is 8×8 block.

12. The transformation and/or inverse transformation apparatus of claim 5, wherein the M is 4.

13. The transformation and/or inverse transformation apparatus of claim 6, wherein the M is 4.

14. An audio and/or video codec comprising a transformation and/or inverse transformation apparatus and supporting multiple data formats, comprises:
a plurality of ROM tables, which are referenced when transforming and/or inversely transforming input data based on the format or size of the input data; and
a transformation and/or inverse transformation unit, which selects one of the ROM tables based on the format or size of the input data and transforms and/or inversely transforms the input data with reference to the selected ROM table,
wherein the transformation and/or inverse transformation unit simultaneously processes a total of 2M data in parallel regardless of the format or size of the input data.

15. A transformation and/or inverse transformation method used in an audio and/or video codec, the transformation or inverse transformation method comprising:
selecting one of a plurality of ROM tables in consideration of the format or size of the input data; and
transforming and/or inversely transforming the input data with reference to the selected ROM table,
wherein in the transforming or inversely transforming of the input data, a total of 2M data are simultaneously processed in parallel regardless of the format or size of the input data.

16. The transformation or inverse transformation method of claim 15, wherein the transforming and/or inversely transforming of the input data, comprises:
performing a first transformation and/or inverse transformation operation on the input data in a row direction; and
performing a second transformation and/or inverse transformation operation on the input data in a column direction, wherein the transformation or inverse transformation method further comprises performing a transpose operation on the input data so that rows and columns of the input data can be transposed after the performing of the first transformation or inverse transformation operation.

17. The transformation and/or inverse transformation method of claim 16, in the performing of the transpose operation, a transpose operation is performed on the input data processed in the performing of the first transformation or inverse transformation operation in units of 2M×2M blocks.

18. The transformation and/or inverse transformation method of claim 17, wherein in the performing of the first transformation or inverse transformation operation, if the type of transformation or inverse transformation to be performed on the input data is 2M×2M or 2M×M, an 2M-point transformation or inverse transformation operation is performed on each row of the input data, which is comprised of 2M coefficients, and otherwise, a pair of M-point transformation or inverse transformation operations are performed in parallel on each row of the input data.

19. The transformation and/or inverse transformation method of claim 16, wherein in the performing of the second transformation and/or inverse transformation operation, if the type of transformation and/or inverse transformation to be performed on the input data is 2M×2M or 2M×M, an 2M-point transformation and/or inverse transformation operation is performed on each row of the input data, which is comprised of 8 coefficients, and otherwise, a pair of M-point transformation or inverse transformation operations are performed in parallel on each column of the input data.

20. The transformation and/or inverse transformation method of claim 15, wherein the format of the input data is one of MPEG-2 and VC1.

21. The transformation and/or inverse transformation method of claim 15, wherein the size of the input data is one of 8×8, 8×4, 4×8, and 4×4.

22. The transformation and/or inverse transformation method of claim 14, wherein the M is 4.

23. The transformation and/or inverse transformation method of claim 15, wherein the M is 4.
